(19) United States
(12) Patent Application Publication
(10) Pub. No.: US 2023/0229850 A1
(43) Pub. Date: Jul. 20, 2023

(54) SMART TABULAR PASTE FROM A CLIPBOARD BUFFER

(71) Applicant: Microsoft Technology Licensing, LLC, Redmond, WA (US)

(72) Inventors: Mohammad RAZA, Redmond, WA (US); Arjun RADHAKRISHNA, Seattle, WA (US); José Pablo CAMBRONERO SÁNCHEZ, New Haven, CT (US); Sumit GULWANI, Sammamish, WA (US); John Francis LAM, Redmond, WA (US); Vu Minh LE, Redmond, WA (US); Daniel MORRIS, Seattle, WA (US); Daniel Adam PERELMAN, Seattle, WA (US); Daniel Galen SIMMONS, Sammamish, WA (US); Gustavo ARAUJO SOARES, Seattle, WA (US); Ashish TIWARI, Sammamish, WA (US)

(21) Appl. No.: 17/576,652

(22) Filed: Jan. 14, 2022

(51) Int. Cl. G06F 40/154; G06F 9/54; G06F 40/143; G06N 20/00; G06F 40/18; G06F 40/183

(52) U.S. Cl. CPC G06F 40/154; G06F 9/543; G06F 40/143; G06N 20/00; G06F 40/18; G06F 40/183

(57) ABSTRACT

Pasting content from a clipboard buffer as structured tabular data. A computer system determines a data type of content within a clipboard buffer. Based on the data type of the content, the computer system identifies a tabular pattern analysis technique to apply to the content. Based on applying the tabular pattern analysis technique to the content, the computer system identifies a portion of tabular content within the content. Using a clipboard application programming interface, the computer system presents the portion of tabular content to an application as paste data that is structured as a set of rows and a set of columns.

### BACKGROUND

Tabular data is data that can be arranged into a table comprising rows and columns. Tabular data can appear in a variety of document formats, such as plain text, hyper-text markup language (HTML), JavaScript object notation (JSON), portable document format (PDF), rich text format (RTF), extensible markup language (XML), Microsoft Office formats, comma-separated values (CSV), and the like. Moving tabular data from one application (and corresponding document format) to another is a task that cuts across many different kinds of users and scenarios. For example, data analysts may be interested in acquiring tabular data from a variety of different sources like webpages, PDFs, and Microsoft Word documents and moving that tabular data into spreadsheets. In another example, business users may be interested in getting tabular data into a spreadsheet application (e.g., Microsoft Excel) or a business analytics tool (e.g., Microsoft PowerBI) to run data analyses and generate reports and charts. In another example, data scientists may want to incorporate tabular data into computational notebooks, such as Jupyter Notebooks. Even end-users often move tabular data from webpages to productivity applications, such as spreadsheet applications such as Microsoft Excel (e.g., to use sorting or filtering capabilities that may not be available in the webpage itself), word processing applications such as Microsoft Word (e.g., to create tables within documents), and presentation applications such as Microsoft PowerPoint (e.g., to create tables within slides).

### BRIEF SUMMARY

However, due to differences between applications and data formats, and a lack of standards for representing tabular data within even a given data format, moving tabular data from one application or document format to another is difficult, and often involves manual action by a user to reformat source data into a tabular form. Additionally, while some applications (e.g., Microsoft Excel and Microsoft PowerBI) support custom data connectors that can be used to import tabular data, these data connectors suffer from problems related to discoverability (e.g., a user has to specifically go looking for such a tool), ease-of-use, and non-universality (e.g., each data connector is specific to one data source application and one target application).

At least some embodiments described herein address challenges of moving tabular data from one application (or data source) to another with a “universal” smart tabular paste from a clipboard buffer. These embodiments allow a user to copy source content comprising tabular data from any source application (or source file) in a variety of formats, and then paste that tabular data into any destination application in a structured form. Thus, a user only need only copy-and-paste between applications, and the embodiments herein automatically analyze the contents of the clipboard in the background and transform those contents into a structured tabular form to be pasted into the target application.

Thus, the embodiments described herein offer a universal way of moving tabular data, by making moving tabular data as easy as copy-and-paste. This saves considerable time for various kinds of users because those users no longer need to manually reformat data into tabular form. Further, by extending the copy-and-paste paradigm, the embodiments described herein promote discoverability, since a user does not need to seek out specialized tools—such as data connectors—to move tabular data. Notably, in addition to providing improved user experiences, the embodiments herein also conserve computing and energy resources. For example, previously, computing and energy resources would be wasted as a user manually reformatted source data into a tabular form, or as a user sought out and learned specialized tools to reformat tabular data. The embodiments herein, however, enable tabular data movement to be completed quickly and automatically via a simple copy-and-paste, which avoids such waste.

In some aspects, the techniques described herein relate to a method, implemented at a computer system that includes a processor, for pasting content from a clipboard buffer as structured tabular data, the method including: determining a data type of content within a clipboard buffer; based on the data type of the content, identifying a tabular pattern analysis technique to apply to the content; based on applying the tabular pattern analysis technique to the content, identifying a portion of tabular content within the content; and using a clipboard application programming interface (API), presenting the portion of tabular content to an application as paste data that is structured as a set of rows and a set of columns.

In some aspects, the techniques described herein relate to a computer system for pasting content from a clipboard buffer as structured tabular data, including: a processor; and a computer storage media that stores computer-executable instructions that are executable by the processor to cause the computer system to at least: determine a data type of content within a clipboard buffer; based on the data type of the content, identify a tabular pattern analysis technique to apply to the content; based on applying the tabular pattern analysis technique to the content, identify a portion of tabular content within the content; and using a clipboard API, present the portion of tabular content to an application as paste data that is structured as a set of rows and a set of columns.

In some aspects, the techniques described herein relate to a computer program product including a computer storage media that stores computer-executable instructions that are executable by a processor to cause a computer system to paste content from a clipboard buffer as structured tabular data, the computer-executable instructions including instructions that are executable by the processor to cause the computer system to at least: determine a data type of content within a clipboard buffer; based on the data type of the content, identify a tabular pattern analysis technique to apply to the content; based on applying the tabular pattern analysis technique to the content, identify a portion of tabular content within the content; and using a clipboard API, present the portion of tabular content to an application as paste data that is structured as a set of rows and a set of columns.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates smart tabular pasting from a clipboard buffer;

FIG. 2 illustrates an example of a tabular past component;

FIG. 3A illustrates an example showing a web browser window that comprises webpage content;

FIG. 3B illustrates an example of selected content of a webpage;

FIG. 4 illustrates a prior art example of pasting copied content of a webpage into a spreadsheet;

FIG. 5 illustrates an example of pasting copied content of a webpage into a spreadsheet as structured tabular data;

FIG. 6A illustrates an example of providing paste-by-example input;

FIG. 6B illustrates an example of pasting copied content of a webpage into a spreadsheet based on paste-by-example input; and

FIG. 7 illustrates a flow chart of an example method for pasting content from a clipboard buffer as structured tabular data.

### DETAILED DESCRIPTION

At least some embodiments described herein address challenges of moving tabular data from one application (or data source) to another with a “universal” smart tabular paste from a clipboard buffer. These embodiments allow a user to copy source content comprising tabular data from any source application (or file) in a variety of formats, and then paste that tabular data into any destination application in a structured form. Thus, a user only need only copy-and-paste between applications, and the embodiments herein analyze the contents of the clipboard in the background and transform those contents into proper tabular form to be pasted into the target application.

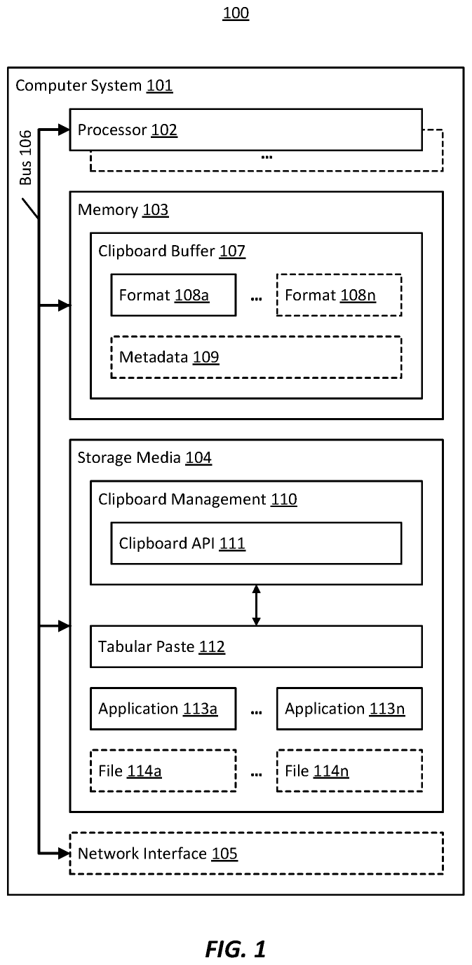

FIG. 1 illustrates an example computer architecture 100 that facilitates smart tabular pasting from a clipboard buffer. As shown, computer architecture 100 includes a computer system 101 comprising a processor 102 (or a plurality of processors), a memory 103, and a storage media 104, all interconnected by a bus 106. As shown, computer system 101 may also include a network interface 105 (also interconnected by the bus 106) for communicating with one or more other computer systems.

The storage media 104 is illustrated as storing computer-executable instructions implementing at least a clipboard management component 110 (e.g., as part of an operating system) and a plurality of applications 113 (i.e., application 113a to application 113n). As shown, the clipboard management component 110 includes a clipboard API 111, which includes interfaces that enable the applications 113 to insert data onto a clipboard buffer 107 (e.g., via a copy operation), and that enable the applications 113 retrieve data from the clipboard buffer 107 (e.g., via a paste operation). Data inserted by a given application onto the clipboard buffer 107 may be generated by the application itself, may be obtained by the application from a remote computer system (e.g., over the network interface 105), or may be read by the application from one or more of files 114 (i.e., file 114a to file 114n) stored on the storage media 104.

In embodiments, the clipboard API 111 enables the applications 113 to insert data onto, or retrieve data from, the clipboard buffer 107 using one or more of data formats 108 (i.e., data format 108a to data format 108n). Example data formats 108 include plain text, HTML, RTF, and the like. In an example, application 113a (e.g., a web browser) inserts data onto the clipboard buffer 107 using a data format 108a of HTML, and the clipboard management component 110 exposes that data to application 113n (e.g., a spreadsheet application) in the data format 108a of HTML, as well as a data format 108n of plain text.

In embodiments, the clipboard API 111 also enables the applications 113 to provide metadata 109 to be associated with the inserted data. In an example, when application 113a (e.g., a web browser) inserts data onto the clipboard buffer 107, the application 113a also specifies information about the source of that data (e.g., a uniform resource locator (URL) associated with the data, or one of files 114 from which the data was sourced), and the clipboard management component 110 stores this information as metadata 109.

The storage media 104 is also illustrated as storing computer-executable instructions implementing a tabular paste component 112. In various embodiments, the tabular paste component 112 is a standalone component (e.g., as part of an operating system or an extension thereto), is part of the clipboard management component 110 itself, and/or is part of one (or more) of applications 113. In general, the tabular paste component 112 facilitates the moving of tabular data from one application (or data source) to another, by providing functionality that enables a “universal” smart tabular paste from the clipboard buffer 107. The tabular paste component 112 allows source content that has been copied into the clipboard buffer 107 to be pasted as tabular data into any destination application in a structured form. Thus, a user only has to copy-and-paste between applications, and the tabular paste component 112 analyzes the contents of the clipboard buffer 107 in the background and transforms those contents into proper tabular form to be pasted into the target application.

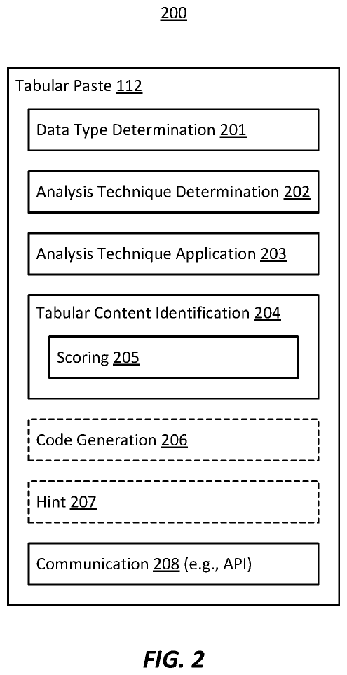

FIG. 2 illustrates an example 200 showing additional detail of the tabular paste component 112 of FIG. 1. Each sub-component of the tabular paste component 112 depicted in FIG. 2 represents various functionalities that the tabular paste component 112 might implement in accordance with various embodiments described herein. It will be appreciated, however, that the depicted sub-components—including their identity and arrangement—are presented merely as an aid in describing various embodiments of the tabular paste component 112.

In embodiments, the tabular paste component operates when one of applications 113 initiates a request (e.g., to the clipboard API 111, to a communication component 208) that a tabular data table be retrieved from the clipboard buffer 107, and/or initiates a request (e.g., to the clipboard API 111, to a communication component 208) for an identity of available data tables within the clipboard buffer 107. In embodiments, a data type determination component 201 determines one or more data types of available clipboard content stored within the clipboard buffer 107. For example, the data type determination component 201 determines which of data formats 108 is (or are) available for clipboard content stored within the clipboard buffer 107. In embodiments, based on which of data formats 108 is (or are) available within the clipboard buffer 107, an analysis technique determination component 202 determines a tabular analysis technique (or techniques) that can be applied to the clipboard content, and an analysis technique application component 203 applies that technique (or techniques) to the clipboard content.

In one example, a data format is HTML, and the analysis technique determination component 202 identifies an analysis technique comprising the generation of cascading style sheet (CSS) selectors, such as a set of row CSS selectors and a set of column CSS selectors, which select tabular data from a document object model (DOM) defined by that HTML-formatted clipboard content. In embodiments, these techniques involve analysis of HTML-formatted clipboard content in order to identify tabular content that occurs in an interleaving, regular pattern; and generation of CSS selectors to select that tabular content from among the HTML-formatted clipboard content.

In another example, the analysis technique determination component 202 identifies an analysis technique comprising the generation of regular expressions that select tabular data from plain text content, XML content, PDF content, CSV content, and the like. In embodiments, these techniques involve the generation of potential regular expressions based on the clipboard content (e.g., using whitespace, formatting characters, etc. as separators), and selecting a subset of those regular expressions that generate aligned data when applied to the clipboard content.

The foregoing examples of analysis techniques comprising the use of CSS selectors, or the use of regular expressions, are illustrative only and it will be appreciated by one of ordinary skill in the art that a variety of other analysis techniques could be utilized—such as the use of visual layout languages like SXPath. In embodiments, the generation of CSS selectors, regular expressions, SXPath, and the like, utilizes predictive program synthesis techniques that generate an extraction program from input-only examples. Details of such techniques are described in, for example, Raza, Mohammad, and Sumit Gulwani. “Automated data extraction using predictive program synthesis.” Proceedings of the AAAI Conference on Artificial Intelligence. Vol. 31. No. 1. 2017.

Other analysis techniques are also possible. For example, in embodiments, the analysis technique determination component 202 identifies an analysis technique comprising inputting the clipboard content into a trained artificial intelligence/machine learning model.

Based on the analysis technique application component 203 having applied a tabular analysis technique (or techniques) to the clipboard content, a tabular content identification component 204 identifies one or more potential tabular data tables within the clipboard content. For example, based on the analysis technique application component 203 having generated a set of one or more CSS selectors for HTML clipboard content, the tabular content identification component 204 applies that set of CSS selectors to the HTML clipboard content to identify one or more potential tabular data tables within the HTML clipboard content. In another example, based on the analysis technique application component 203 having generated a set of one or more regular expressions for plain text clipboard content, the tabular content identification component 204 applies that set of regular expressions to the plain text clipboard content to identify one or more potential tabular data tables within the plain text clipboard content.

In embodiments, the tabular content identification component 204 identifies a plurality of potential tabular data tables within the clipboard content. In embodiments, when this happens, the tabular content identification component 204 uses a scoring component 205 to assign a score to each of those potential tabular data tables. In embodiments, each score indicates a predicted likelihood that the corresponding potential data table would be a data table that a user would want to paste into an application; therefore, the scoring component 205 operates to rank the plurality of potential tabular data tables based on those scores.

In embodiments, the scoring component 205 scores potential tabular data tables based on one or more of (i) a size of the potential tabular data table (e.g., with larger data tables scoring as more likely to be a table that a user would want than smaller data tables), (ii) a consistency of the type of data that appears within each column of the potential tabular data table (e.g., with more consistent data tables scoring as more likely to be a table that a user would want than less consistent data tables), (iii) the presence of empty cells within the potential tabular data table (e.g., with more full data tables scoring as more likely to be a table that a user would want than less full data tables), a percentage of the clipboard data that appears in the data table (e.g., with data tables comprising a higher portion of the clipboard data scoring as more likely to be a table that a user would want than data tables comprising lower portions of the clipboard data), and the like. In some embodiments, features such as these are used to train a machine learning model for inferring the best ranking of potential tables.

The communication component 208 communicates one or more identified tabular data tables (or at least the identity thereof) to one of applications 113 via the clipboard API 111. In embodiments, when there is a request that a tabular data table be retrieved from the clipboard buffer 107, the communication component 208 communicates a tabular data table having a highest score (i.e., predicted to be most likely to be a table that a user would want) assigned thereto.

As shown in FIG. 2, the communication component 208 may, in one example, be an API. As mentioned, in an embodiment the tabular paste component 112 is part of the clipboard management component 110 itself; in this embodiment, the communication component 208 may be an extension to the clipboard API 111. As mentioned, in other embodiments, the tabular paste component 112 is a standalone component (e.g., as part of an operating system or an extension thereto) and/or is part of one (or more) of applications 113; in these embodiments, the communication component 208 may interact with the clipboard API 111.

In embodiments, when communicating a tabular data table one of applications 113, the communication component 208 communicates that data table as a structured set of rows and columns, using any appropriate format that can be understood by the application. For example, the communication component 208 may structure the data table using CSV, HTML, RTF, and the like.

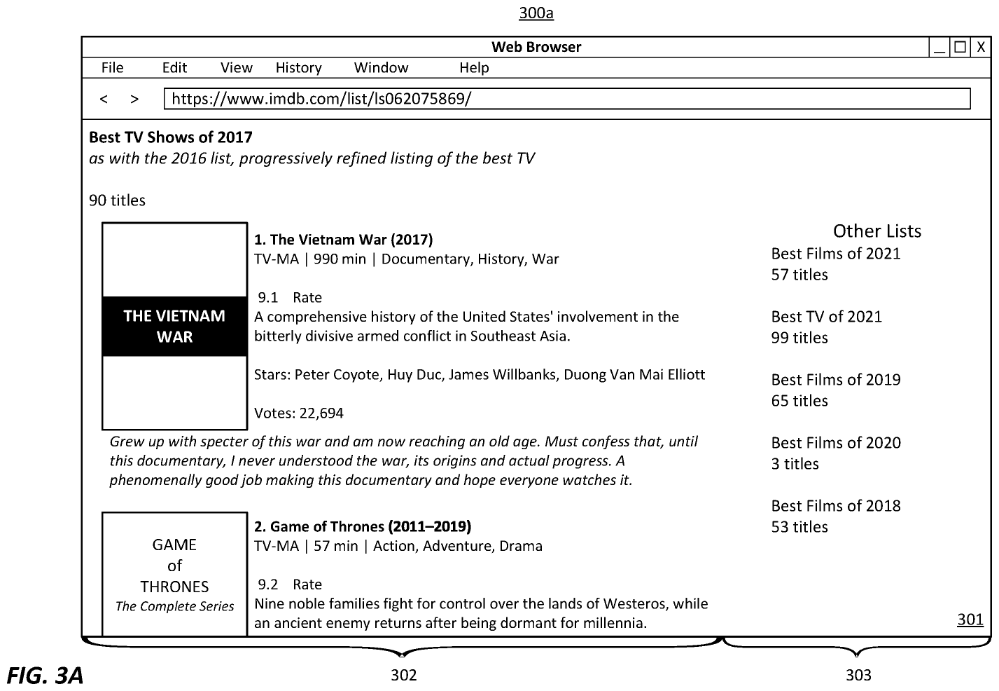

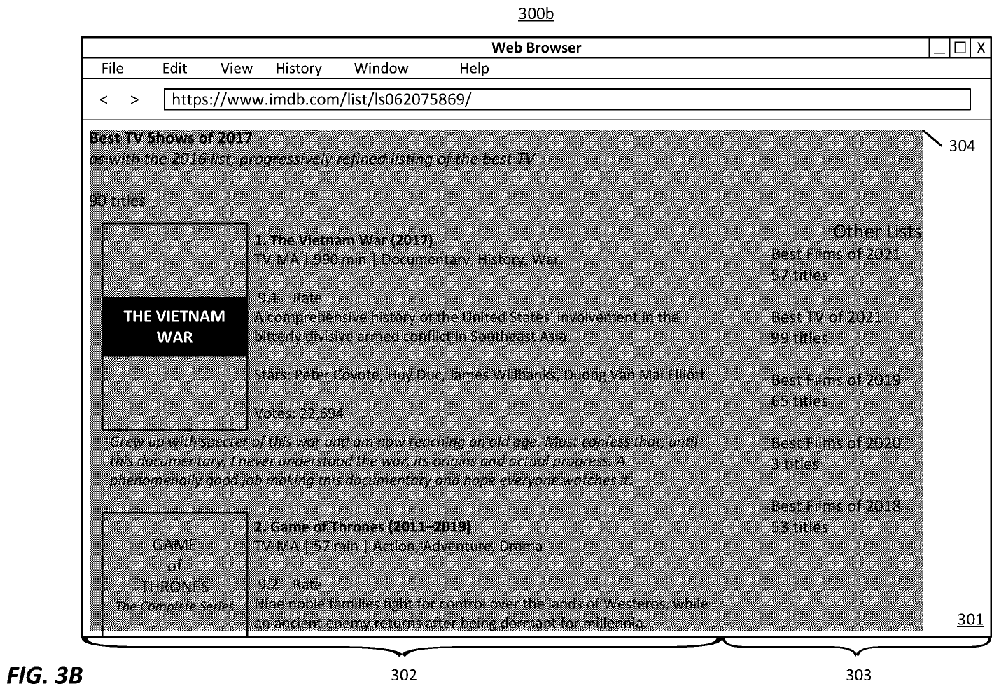

Example operation of the tabular paste component 112 is now presented in connection with FIGS. 3A, 3B, 4, and 5. Initially, FIG. 3A illustrates an example 300a showing a web browser window 301 (e.g., generated by application 113a) that comprises webpage content. In particular, the web browser window 301 shows a webpage comprising a main content portion 302 comprising a list of the “Best TV Shows of 2017,” and a side portion 303 linking to other similar lists. Next, FIG. 3B illustrates an example 300b of selected content of a webpage, in which all content of the webpage of example 300a has been selected (e.g., using a CTL-a keystroke, a CMD-a keystroke, and the like), as illustrated by a shaded box 304. In embodiments, this content is also inserted onto to the clipboard buffer 107 (e.g., using a CTL-c keystroke, a CMD-c keystroke, and the like).

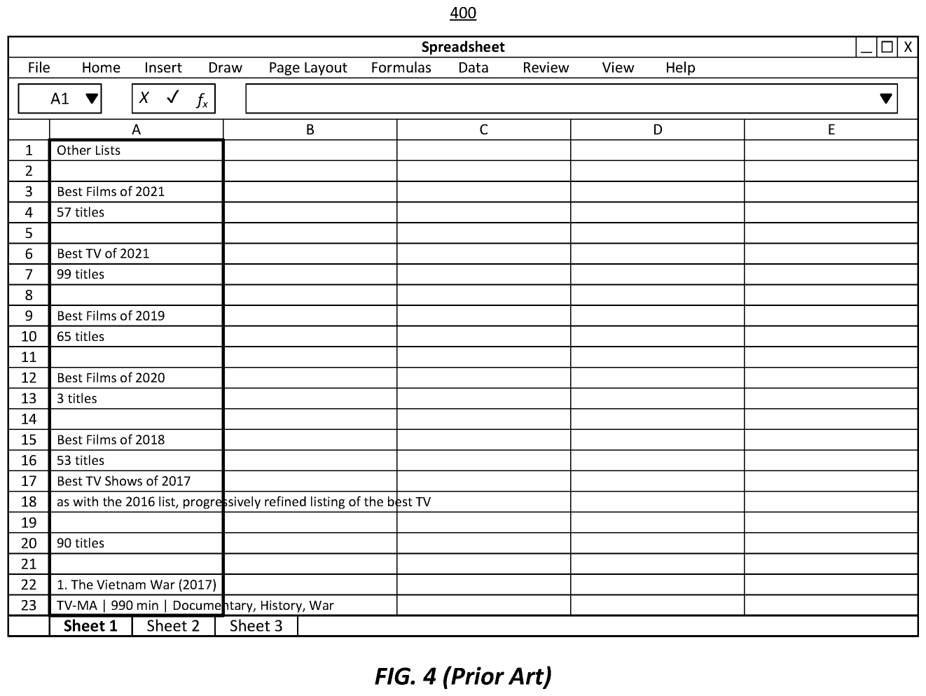

FIG. 4 illustrates an example 400 of pasting copied content of a webpage into a spreadsheet using conventional techniques. In particular, example 400 shows that, conventionally, the webpage content selected and copied in example 300b would be pasted into a spreadsheet application in an unstructured manner; thus, the spreadsheet application would treat that webpage content as a single blob of data. As shown, the spreadsheet application may therefore insert that data into a spreadsheet as a single column of data that intermingles both the side portion 303 and the main content portion 302 of the webpage. Notably, the spreadsheet shown in example 400 would need significant manual work to be reformatted into a form that would be usable.

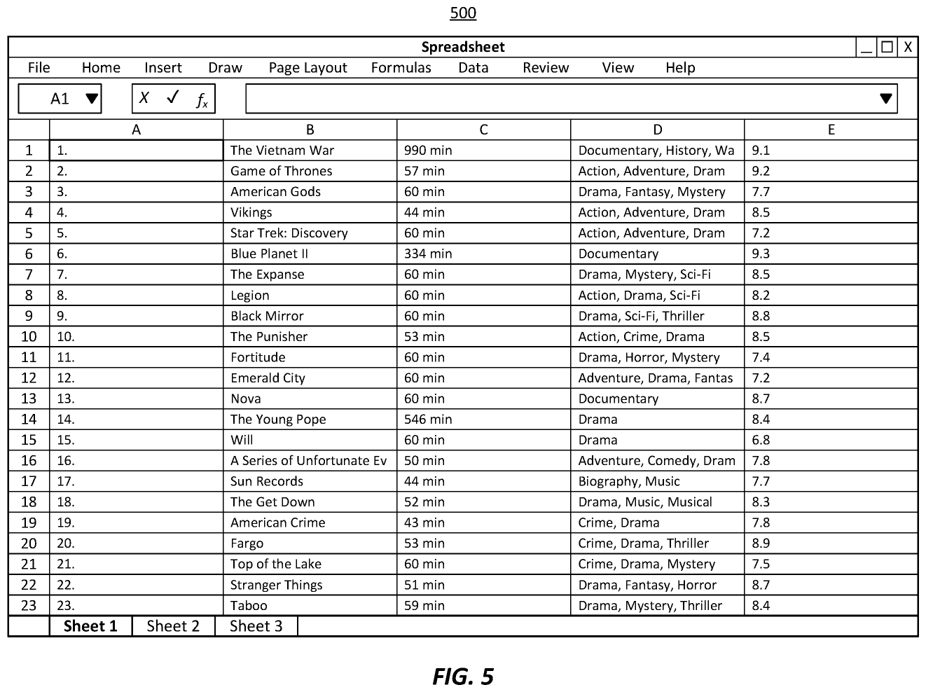

In accordance with the embodiments herein, FIG. 5 illustrates an example 500 of pasting copied content of a webpage into a spreadsheet as structured tabular data, using the tabular paste component 112 disclosed herein. In example 500, the spreadsheet application (e.g., application 113n) has requested that contents of the clipboard buffer 107 be pasted as tabular data. Thus, the tabular paste component 112 has operated to identify tabular data within the webpage content—here, a table comprising details for each of the ninety TV shows listed on the webpage of example 300a and example 300b. Notably, through operation of the analysis technique application component 203 (e.g., to generate CSS selectors, regular expressions, and the like), and through operation of the tabular content identification component 204 (e.g., to apply those CSS selectors, regular expressions, etc. to clipboard content to identify tabular data tables), the tabular paste component 112 has returned only tabular data—while omitting non-tabular data. For example, the tabular paste component 112 has omitted header data from the main content portion 302 of the webpage and has omitted the side portion 303 of the webpage. Thus, through a simple copy operation (e.g., by application 113a) of the webpage content shown in example 300a and example 300b, and through a simple paste operation (e.g., by application 113n) the spreadsheet shown in example 500 comprises clean, structured, and immediately actionable data from the webpage.

As mentioned, in embodiments the communication component 208 communicates a data table as a structured set of rows and columns. In example 500, the spreadsheet application (e.g., application 113n) has interpreted that data as rows and columns within a spreadsheet. However, other applications may interpret that data in alternate forms. For example, if application 113n is an integrated development environment (IDE), the application 113n may interpret the data in a form appropriate for an active project type. For instance, for a Python project type, the application 113n may interpret the data as a DataFrame.

In some embodiments, the tabular paste component 112 comprises a code generation component 206 that generates code for obtaining updates to the tabular content within the clipboard buffer 107. In embodiments, the code generation component 206 utilizes metadata 109 associated with the clipboard buffer 107 to determine a source of clipboard content, and then generates code to fetch new content from the source, to select a subset of tabular data from that content (e.g., using the CSS selectors, regular expressions, and the like generated by the analysis technique application component 203), and to structure it in a tabular form. Thus, in embodiments, not only does the tabular paste component 112 extract tabular data from the clipboard buffer 107, but via code generation component 206 it also eases the task of updating the data and importing data from similar sources.

In one example, following is some example Python code, generated by the code generation component 206, for obtaining updates to tabular content associated with the web page of example 300a and example 300b:

| | |
|---|---|
| 1. | from bs4 import BeautifulSoup |
| 2. | import requests |
| 3. | import pandas as pd |
| 4. | |
| 5. | soup = |
| | BeautifulSoup(requests.get(′https://www.imdb.com/list/1s062075869/′). |
| | text) |
| 6. | |
| 7. | # Row and column CSS selectors |
| 8. | row_selector = ′.lister-item-index′ |
| 9. | col_selectors = [′.lister-item-index′, ′.lister-item-header A′, |
| | ′.runtime,′ ′.genre′, ′.ipl-rating-star.small′, ′ipl-rating- |
| | star_rating′, ′.ipl-rating_widget + *′, ′.lister-item-year′, ...] |
| 10. | col_nodes = [soup.select (cs) for cs in col_selectors] |
| 11. | row_nodes = soup.select (row_selector) |
| 12. | num_cols = len(col_nodes) |
| 13. | num_rows = len(row_nodes) |
| 14. | |
| 15. | # Create dataframe with column nodes aligned according to row |
| | selector |
| 16. | result = [[None for in range (num_cols)] for j in range (num_rows)] |
| 17. | curr_row = −1 |
| 18. | for element in soup.select (′*′): |
| 19. | curr_row = curr_row + 1 if any (element is x for x in row_nodes) |
| | else curr_row |
| 20. | if curr_row >= 0: |
| 21. | for i in range (num_cols): |
| 22. | if result [curr_row][i] is None and any (element is x for x |
| | in col_nodes[i]): |
| 23. | result[curr_row][i] = str(element.text.strip() or ′′) |
| 24. | |
| 25. | # finalize the table by replacing None cell values to the empty |
| | string |
| 26. | result = ([result[r][c] or ′′ for c in range (num_cols)] for r in |
| | range (num_rows)] |
| 27. | df = pd.DataFrame(result) |
| 28. | df |

Here, the example code fetches updated content from a source URL (i.e., line 5), defines row and column CSS selectors and a corresponding data table (i.e., lines 8 to 13), and then generates a DataFrame using the tabular data selected by those CSS selectors (i.e., lines 16 to 28). Note that, for brevity, in line 9 a full enumeration of CSS selectors has been truncated in the example Python code (i.e., as indicated by ellipses in within line 9). In one example, the generation of code for obtaining updates to the tabular content within the clipboard buffer 107 is useful for data scientists wanting to incorporate tabular data into computational notebooks, since this generated code is usable to obtain tabular data updates from the source for and integrate those updates into computational notebooks.

In some embodiments, the tabular paste component 112 comprises a hint component 207. In embodiments, the hint component 207 receives hint input from one of applications 113 demonstrating one or more columns of data to be included in tabular data identified from the contents of the clipboard buffer 107. The hint component 207 then provides that hint input to one, or both, of the analysis technique application component 203 or the tabular content identification component 204 to guide operation of those component(s). In one example, based on providing hint input to the analysis technique application component 203, the analysis technique application component 203 uses the hint input to guide a determination of which CCS selectors, regular expressions, etc. to generate. In another example, based on providing hint input to the tabular content identification component 204, the tabular content identification component 204 uses the hint input to determine which content to include when outputting tabular data via the communication component 208. In either example, the hint input can be used to determine what data constitutes a tabular data table, can be used to join two prospective data tables into one data table, can be used to select a subset of identified tabular data, etc. Examples of hint-based analysis techniques are described in, for example, Raza, Mohammad, and Sumit Gulwani. “Web data extraction using hybrid program synthesis: a combination of top-down and bottom-up inference” Proceedings of the 2020 ACM SIGMOD International Conference on Management of Data. 2020.

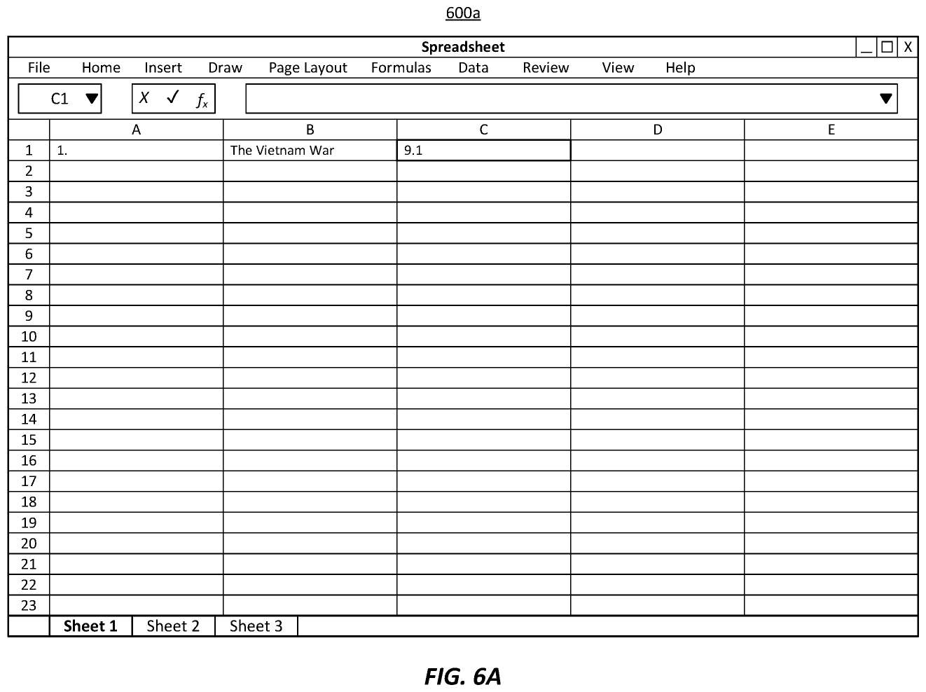

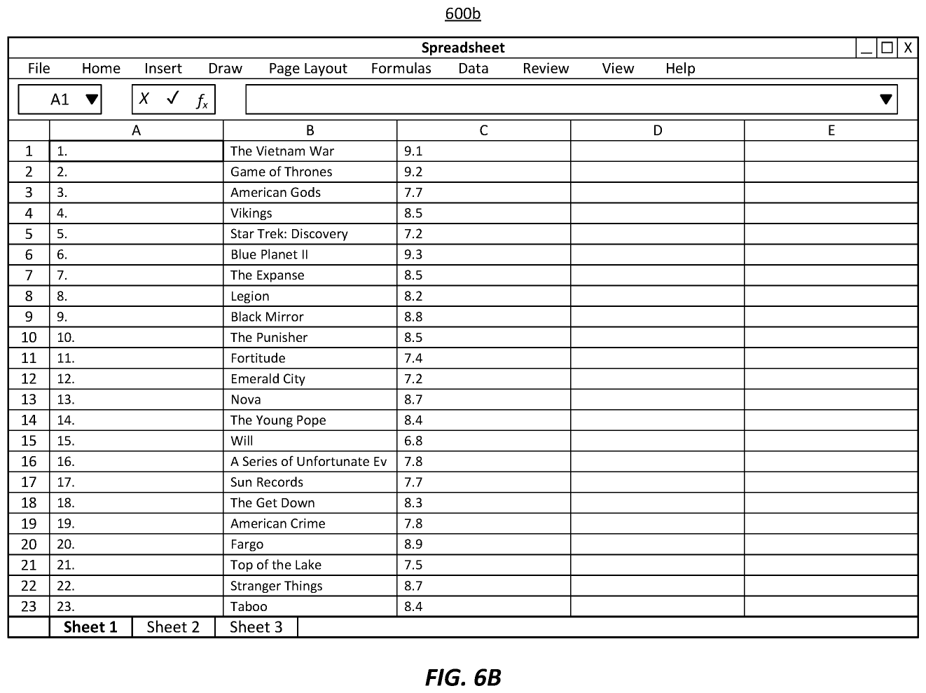

To demonstrate operation of the hint component 207, FIG. 6A illustrates an example 600a of providing paste-by-example input. In example 600a, a user has provided hint input comprising desired data for three columns of data (i.e., as shown in cells A1, B1, and C1). Based on this hint input, FIG. 6B illustrates an example 600b of pasting copied content of a webpage into a spreadsheet based on paste-by-example input. Here, example 600b is populated from the same data source as example 500, but rather than including all columns of data, example 600b only includes a selected subset (e.g., the columns that were indicated into columns A, B, and E in example 500).

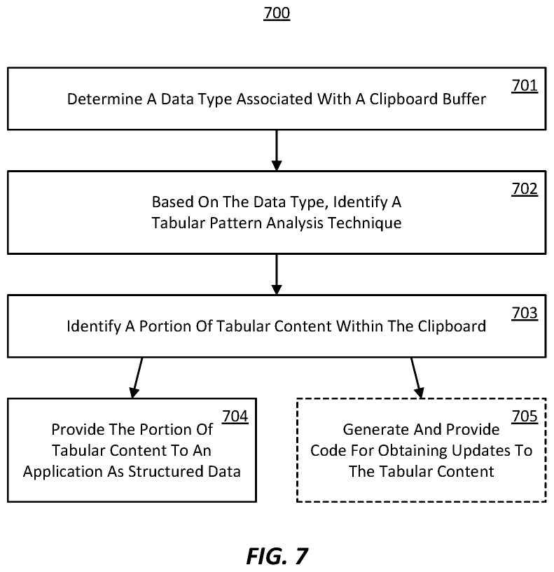

The components of the tabular paste component 112 are now described further in connection with FIG. 7, which illustrates a flow chart of an example method 700 for pasting content from a clipboard buffer as structured tabular data. In embodiments, instructions for implementing method 700 are encoded as computer-executable instructions (e.g., tabular paste component 112) stored on a computer program product (e.g., storage media 104) that are executable by a processor (e.g., processor 102) to cause a computer system (e.g., computer system 101) to perform method 700.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

As mentioned, in embodiments the tabular paste component operates when one of applications 113 initiates a request that a tabular data table be retrieved from the clipboard buffer 107; thus, in some embodiments, method 700 is triggered by a request, at the clipboard API 111, for a tabular paste. In other embodiments, the tabular paste component operates when one of applications 113 initiates a request for an identity of available data tables within the clipboard buffer 107; thus, in some embodiments, method 700 is triggered by a request, at the clipboard API 111, for an identity of available tabular content.

Referring to FIG. 7, in embodiments, method 700 comprises an act 701 of determining a data type associated with a clipboard buffer. In some embodiments, act 701 comprises determining a data type of content within a clipboard buffer. In an example, the data type determination component 201 determines what data format (or formats) are available for clipboard content stored within the clipboard buffer 107. For example, in the context of a paste initiated by the spreadsheet application shown in example 500, the data type determination component 201 may determine (e.g., via the clipboard management component 110) that the clipboard content stored within the clipboard buffer 107 is available in at least a data format 108a comprising HTML.

Method 700 also comprises an act 702 of, based on the data type, identifying a tabular pattern analysis technique. In some embodiments, act 702 comprises, based on the data type of the content, identifying a tabular pattern analysis technique to apply to the content. Continuing the example of act 701, the analysis technique determination component 202 may determine that, because the clipboard content stored within the clipboard buffer 107 is available in a data format 108a comprising HTML, an appropriate analysis technique is a generation of CSS selectors. Alternatively, if the clipboard content comprises plain text, the analysis technique determination component 202 may determine that an appropriate analysis technique is a generation of regular expressions.

In some embodiments, act 701 may determine that clipboard content stored within the clipboard buffer 107 is available in multiple data formats, such as a data format 108a comprising HTML and a data format 108n comprising plain text. In these embodiments, the analysis technique determination component 202 may prefer one analysis technique over another; for example, if HTML and plain text formats are available, the analysis technique determination component 202 may prefer generation of CSS selectors from HTML content over generation of regular expressions from plain text.

Method 700 also comprises an act 703 of identifying a portion of tabular content within the clipboard. In some embodiments, act 703 comprises, based on applying the tabular pattern analysis technique to the content, identifying a portion of tabular content within the content. In an example, the analysis technique application component 203 can apply the analysis technique identified in act 702 (e.g., generation of CSS selectors, generation of regular expressions, etc.), and the tabular content identification component 204 can then use the output of the analysis technique application component 203 to identify tabular content within the clipboard content (e.g., by applying the generated CSS selectors, by applying the generated regular expressions, etc.).

In some embodiments, the data type determined in act 701 is HTML and act 703 therefore generates and applies CSS selectors to clipboard data. Thus, in some embodiments of method 700, the data type of the content is HTML formatted data, and the tabular pattern analysis technique comprises generating a set of CSS selectors that extract the portion of tabular content from the content.

In some embodiments, the data type determined in act 701 is plain text and act 703 therefore generates and applies regular expressions to clipboard data. Thus, in some embodiments of method 700, the data type of the content is plain text, and the tabular pattern analysis technique comprises generating a set of regular expressions that extract the portion of tabular content from the content.

In some embodiments, based on the data type determined in act 701, act 703 therefore inputs clipboard data to a machine learning model. Thus, in some embodiments of method 700, the tabular pattern analysis technique includes inputting the content to a machine learning model.

As mentioned, in embodiments the tabular content identification component 204 identifies a plurality of potential tabular data tables within clipboard content, and then uses a scoring component 205 to assign a score to each of those potential tabular data tables. Thus, in some embodiments, based on applying the tabular pattern analysis technique to the content, method 700 identifies a plurality of portions of tabular content within the content.

As mentioned, when there is a request that a tabular data table be retrieved from the clipboard buffer 107, in some embodiments the communication component 208 communicates a tabular data table having a highest score (i.e., predicted to be most likely to be a table that a user would want) assigned thereto. Thus, in embodiments, method 700 also includes assigning a score to each of the plurality of portions of tabular content, and selecting the portion of tabular content, from among the plurality of portions of tabular content, based on the portion of tabular content having a highest score assigned thereto.

As mentioned, in embodiments a hint component 207 receives hint input from one of applications 113 demonstrating one or more columns of data to be included in tabular data identified from the contents of the clipboard buffer 107.

In embodiments, this hint input is used by the analysis technique application component 203 to guide a determination of which CCS selectors, regular expressions, etc. to generate. Thus, some embodiments of method 700 at least one CSS selector of the set of CSS selectors is selected based on receiving, at the clipboard API, hint tabular content structured as a set of rows and a set of columns. In other embodiments of method 700, at least one regular expression of the set of regular expressions is selected based on receiving, at the clipboard API, hint tabular content structured as a set of rows and a set of columns.

In embodiments, hint input is used by the tabular content identification component 204 to determine which content to include when outputting tabular data via the communication component 208. For example, in some embodiments, method 700 also includes receiving, at the clipboard API, hint tabular content structured as a set of rows and a set of columns; and selecting the portion of tabular content, from among the plurality of portions of tabular content, based on the portion of tabular content aligning with the hint tabular content. For instance, example 600a demonstrated a hint input (i.e., the text within cells A1, B1, and C1), while example 600b demonstrated a pasted subset of columns that aligned with that hint input. In some embodiments, based on the hint tabular content, the portion of tabular content is a union of two or more of plurality of portions of tabular content. In some embodiments, based on the hint tabular content, the portion of tabular content is a selected subset of available tabular content.

Method 700 also comprises an act 704 of providing the portion of tabular content to an application as structured data. In some embodiments, act 704 comprises, using a clipboard API, presenting the portion of tabular content to an application as paste data that is structured as a set of rows and a set of columns. In an example, the communication component 208 communicates the portion of tabular content identified by the tabular content identification component 204 to a requesting one of one of applications 113 via the clipboard API 111.

As mentioned, in embodiments the portion of tabular content is a selected subset of available tabular content (e.g., based on a received hint). Thus, in embodiments, based on the hint tabular content, act 704 includes less than an entirety of the portion of tabular content when presenting the portion of tabular content to the application.

As demonstrated in connection with example 500a, through operation of the analysis technique application component 203 (e.g., to generate CSS selectors, regular expressions, and the like), and through operation of the tabular content identification component 204 (e.g., to apply those CSS selectors, regular expressions, etc. to clipboard content to identify tabular data tables), in some embodiments the tabular paste component 112 returns only tabular data—while omitting non-tabular data. Thus, in some embodiments of method 700, the portion of tabular content comprises less than an entirety of the content within the clipboard buffer. For instance, in example 500 the tabular paste component 112 omitted header data from the main content portion 302 of the webpage and omitted the side portion 303 of the webpage.

As mentioned, in embodiments a code generation component 206 generates code for obtaining updates to the tabular content within the clipboard buffer 107. Thus, some embodiments, method 700 also comprises an act 705 of generating and providing code for obtaining updates to the tabular content. In some embodiments, act 705 comprises identifying, from the clipboard buffer, a URL associated with the content (e.g., from metadata 109); creating generated code that includes at least: a first portion of generated code (e.g., line 5 of the example Python code, supra) that fetches new content from the URL, a second portion of generated code (e.g., lines 8 to 13 of the example Python code, supra) that selects a subset of the new content using the set of CSS selectors, and a third portion of generated code (e.g., lines 16 to 28 of the example Python code, supra) that structures the subset of the new content as a set of rows and a set of columns; and using the clipboard API, presenting the generated code to the application.

Accordingly, the embodiments described herein address challenges of moving tabular data from one application (or data source) to another with a “universal” smart tabular paste from a clipboard buffer. These embodiments allow a user to copy source content comprising tabular data from any source application or file in a variety of formats, and then paste that tabular data into any destination application in a structured form. Thus, a user only has to copy and paste between applications, and the embodiments herein analyze the contents of the clipboard in the background, and transforms those contents into proper tabular form to be pasted into the target application.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims. These embodiments offer a universal way of moving tabular data, by making moving tabular data as easy as copy-and-paste. This provides improved user experiences, and conserves computing and energy resources.

Embodiments of the present invention may comprise or utilize a special-purpose or general-purpose computer system (e.g., computer system 101) that includes computer hardware, such as, for example, one or more processors (e.g., processor 102) and system memory (e.g., memory 103), as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 104). Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

1. A method, implemented at a computer system that includes a processor, for pasting content from a clipboard buffer as structured tabular data, the method comprising:
identifying a clipboard buffer comprising content, wherein the content includes tabular data and non-tabular data;
determining a data type of the content within the clipboard buffer;
based on the data type of the content, identifying a tabular pattern analysis technique to apply to the content;
based on applying the tabular pattern analysis technique to the content, identifying a portion of tabular content within the content, wherein the portion of tabular content includes at least a subset of the tabular data within the content and omits the non-tabular data within the content; and
using a clipboard application programming interface (API), presenting the portion of tabular content to an application as paste data that is structured as a set of rows and a set of columns.

2. The method of claim 1, wherein the method is triggered by a request, at the clipboard API, for a tabular paste.

3. The method of claim 1, wherein the data type of the content is plain text, and wherein the tabular pattern analysis technique comprises generating a set of regular expressions that extract the portion of tabular content from the content.

4. The method of claim 3, wherein at least one regular expression of the set of regular expressions is selected based on receiving, at the clipboard API, hint tabular content structured as a set of rows and a set of columns.

5. The method of claim 1, wherein the data type of the content is hyper-text markup language formatted data, and wherein the tabular pattern analysis technique comprises generating a set of cascading stylesheet (CSS) selectors that extract the portion of tabular content from the content.

6. The method of claim 5, wherein at least one CSS selector of the set of CSS selectors is selected based on receiving, at the clipboard API, hint tabular content structured as a set of rows and a set of columns.

7. The method of claim 5, further comprising:
identifying, from the clipboard buffer, a uniform resource locator (URL) associated with the content;
creating generated code that includes at least:
a first portion of generated code that fetches new content from the URL,
a second portion of generated code that selects a subset of the new content using the set of CSS selectors, and
a third portion of generated code that structures the subset of the new content as a set of rows and a set of columns; and
using the clipboard API, presenting the generated code to the application.

8. The method of claim 1, wherein the tabular pattern analysis technique includes inputting the content to a machine learning model.

9. The method of claim 1, wherein, based on applying the tabular pattern analysis technique to the content, the method identifies a plurality of portions of tabular content within the content.

10. The method of claim 9, further comprising:
assigning a score to each of the plurality of portions of tabular content; and
selecting the portion of tabular content, from among the plurality of portions of tabular content, based on the portion of tabular content having a highest score assigned thereto.

11. The method of claim 9, further comprising:
receiving, at the clipboard API, hint tabular content structured as a set of rows and a set of columns; and
selecting the portion of tabular content, from among the plurality of portions of tabular content, based on the portion of tabular content aligning with the hint tabular content.

12. The method of claim 11, wherein, based on the hint tabular content, the portion of tabular content is a union of two or more of plurality of portions of tabular content.

13. The method of claim 11, further comprising, based on the hint tabular content, including less than an entirety of the portion of tabular content when presenting the portion of tabular content to the application.

14. The method of claim 1, wherein the portion of tabular content comprises less than an entirety of the content within the clipboard buffer.

15. A computer system for pasting content from a clipboard buffer as structured tabular data, comprising:
a processor; and
a computer storage media that stores computer-executable instructions that are executable by the processor to cause the computer system to at least:
identifying a clipboard buffer comprising content, wherein the content includes tabular data and non-tabular data;
determining a data type of the content within liallthe clipboard buffer;
based on the data type of the content, identify a tabular pattern analysis technique to apply to the content;
based on applying the tabular pattern analysis technique to the content, identify a portion of tabular content within the content, wherein the portion of tabular content includes at least a subset of the tabular data within the content and omits the non-tabular data within the content; and
using a clipboard application programming interface (API), present the portion of tabular content to an application as paste data that is structured as a set of rows and a set of columns.

16. The computer system of claim 15, wherein, based on applying the tabular pattern analysis technique to the content, the computer system identifies a plurality of portions of tabular content within the content.

17. The computer system of claim 16, the computer-executable instructions also including instructions that are executable by the processor to cause the computer system to at least:
assign a score to each of the plurality of portions of tabular content; and
select the portion of tabular content, from among the plurality of portions of tabular content, based on the portion of tabular content having a highest score assigned thereto.

18. The computer system of claim 16, the computer-executable instructions also including instructions that are executable by the processor to cause the computer system to at least:
receive, at the clipboard API, hint tabular content structured as a set of rows and a set of columns; and
select the portion of tabular content, from among the plurality of portions of tabular content, based on the portion of tabular content aligning with the hint tabular content.

19. The computer system of claim 15, wherein the portion of tabular content comprises less than an entirety of the content within the clipboard buffer.

20. A computer program product comprising a computer storage media that stores computer-executable instructions that are executable by a processor to cause a computer system to paste content from a clipboard buffer as structured tabular data, the computer-executable instructions including instructions that are executable by the processor to cause the computer system to at least:
identifying a clipboard buffer comprising content, wherein the content includes tabular data and non-tabular data;
determining a data type of the content within the clipboard buffer;
based on the data type of the content, identify a tabular pattern analysis technique to apply to the content;
based on applying the tabular pattern analysis technique to the content, identify a portion of tabular content within the content, wherein the portion of tabular content includes at least a subset of the tabular data within the content and omits the non-tabular data within the content; and
using a clipboard application programming interface (API), present the portion of tabular content to an application as paste data that is structured as a set of rows and a set of columns.
